(19) United States
(12) Patent Application Publication
(10) Pub. No.: US 2012/0048812 A1
(43) Pub. Date: Mar. 1, 2012

(54) Groundwater Remediation Process

(76) Inventor: Wayne A. Terwilliger, Pompano Beach, FL (US)

(21) Appl. No.: 12/339,030

(22) Filed: Dec. 18, 2008

(51) Int. Cl. C02F 1/72; B09C 1/08

(52) U.S. Cl. 210/747.8

(57) ABSTRACT

A groundwater remediation process with an advanced oxidation process (AOP) process called hydroxy-zone. The hydroxy-zone process uses ozone gas injection combined with potassium hydroxide treatment to generate hydroxyl radicals. Hydroxy-zone uses a chemical process in which the chemicals OH⁻ and O₃; are mixed in a liquid and gas form and are then injected into the groundwater below the treatment zone to treat the sorbed and dissolved contaminated layer This particular AOP involves the generation of OH^{o} by the combined reaction of a hydroxide anion (OH⁻) and O³ (ozone) gas

### BACKGROUND

1. Technical Field

This invention relates in general to a pollution control systems, and in particular, it relates to a process for groundwater remediation. Specifically, the invention relates to groundwater remediation by advanced oxidation process (aop) called hydroxy-zone using ozone gas injection combined with potassium hydroxide treatment to generate hydroxyl radicals.

2. Background of the Invention

As industrialization developed over the years, a great deal of material and social progress was made. Unfortunately, there were also a number of undesirable byproducts related to the development of numerous industries. In particular, there is then a substantial amount of contamination of groundwater due to chemicals either dumped or inadvertently spilled onto the ground. As a result, serious health and environmental problems have been caused by groundwater pollution. It would be desirable to have an efficient method of removing or neutralizing dangerous chemicals that are contaminating groundwater in a particular area.

In addition, in the last century the automobile industry has developed at a substantial rate. While the benefits of automobiles are many, and need not be discussed here, they have also brought about several types of pollution which are of concern to the public. One type of pollution comes as a result of the fuel supply systems required to support the automobile industry. In particular, the automobile industry requires a substantial number of fuel stations throughout the country. Each of these stations contains large storage tanks filled with gasoline, diesel, or other fuels. Either of these fuel types can have a severe negative effect on the environment when the storage tanks leak, or the fuel is inadvertently spilled on the ground during the refueling process and ultimately absorbed into the groundwater. It would be desirable to have an expensive and efficient method of removing contaminants such as automobile fuels and other contaminants from the ground.

Gasoline and other petroleum products which are dissolved in groundwater are a severe environmental problem because they are persistent semi-volatile, volatile and solvent contaminants that can be sorbed by the soils and/or trapped in an isolated zone of geology, such as the smear zone. The smear zone is a geologic zone near the water table above and below which is smeared with a contaminant. In a smear zone, the sorbed contaminant slowly releases into the groundwater near the water table interface, sometimes after typical cleanup processes have been utilized causing a “rebound” in dissolved levels in the groundwater. In addition to environmental concerns, these persistent sorbed and dissolved contaminants in the groundwater continue to be a source of financial problems from refinance liability to limiting property redevelopment. It would be desirable to have a method of completely degrading these contaminants in a rapid and effective fashion to provide significant economic savings to owners, developers, and facility operators as well as you provide protection to the environment.

Those skilled in the art will recognize that, in addition to petroleum based products, there are many other types of pollutants coming from a variety of industrial sources which present similar hazards to the environment.

One attempt to address this problem has been to use advanced oxidation processes (AOPs). AOPs are processes which purify water by generating hydroxyl radicals in sufficient quantity to effect water purification. Typical AOPs are O₃H₂O₂, UV/H₂O₂, UV/O₃, UV/H₂O₂/O³. They have been developed in an attempt to produce nonselective and rapid OH^{o} (hydroxyl radical) to oxidize these persistent pollutants. However, known AOPs can be expensive to produce and difficult to apply.

While the prior art has made attempts to address groundwater contamination, it has failed to provide a simple easy to use system which can inexpensively remove contaminants from the groundwater and from the smear zone. In particular, it has failed to provide a system which can produce high levels of hydroxyl radicals, and which can selectively position the hydroxyl radicals in specific areas of contaminated soil.

### SUMMARY OF THE INVENTION

This invention provides groundwater remediation with an advanced oxidation process (AOP) process called hydroxy-zone. The hydroxy-zone process uses ozone gas injection combined with potassium hydroxide treatment to generate hydroxyl radicals. Hydroxy-zone uses a chemical process in which the chemicals OH⁻ and O₃; are mixed in a liquid and gas form and are then injected into the groundwater below the treatment zone to treat the sorbed and dissolved contaminated layer This particular AOP involves the generation of OHO by the combined reaction of a hydroxide anion (OH⁻) and O³ (ozone) gas.

### BRIEF DESCRIPTION OF THE DRAWINGS

FIG. 1 is a site map of a service station that illustrates xylene contamination plumes surrounding fuel pumps.

FIG. 2 is a site map of a service station that illustrates naphthalene contamination plumes surrounding fuel pumps.

FIG. 3 is a site map of a service station that illustrates ozone injection points.

FIG. 4 is a site map of a service station that illustrates ozone injection points and the piping that distributes ozone.

FIG. 5 is a site map of a service station that illustrates vacuum well locations and their respective zones of influence.

FIG. 6 is a site map of a service station that illustrates vacuum well locations and their vacuum pipes.

FIG. 7 illustrates the sub-surface distribution of ozone in relation to the water table.

FIG. 8 illustrates a preferred embodiment of the groundwater remediation system.

### DETAILED DESCRIPTION OF THE PREFERRED EMBODIMENT

Prior to a discussion of the figures, an overview of the invention will be presented. The invention is a groundwater remediation system, called hydroxy-zone, which uses an advanced oxidation process (AOP). Hydroxy-zone uses ozone gas injection combined with a potassium hydroxide treatment to generate hydroxyl radicals in situ. The hydroxyl radicals react with and destroy the groundwater contaminants.

Once the hydroxyl radicals are generated, they aggressively attack virtually all-organic species in several ways. For example, the OH^{o} can abstract a hydrogen atom from water, as with alkanes or alcohols, or it can add itself to the contaminant, as in the case of olefins or aromatic compounds. The attack by the OH^{o}, in the presence of oxygen, initiates a complex cascade of oxidative reactions leading to mineralization of the organic compound. The reaction rate constants, when attacking certain organic compounds for molecular ozone, can range from 0.01 to 10⁴ M⁻¹S⁻¹ versus OH^{o} of 10⁸ to 10¹¹M⁻¹S⁻¹[2]. The hydroxyl radical has one of the highest oxidizing power values. It's oxidizing power level is 2.05, which is close to that of elemental fluorine, 2.25. Ozone itself has an oxidizing power of 1.52.

An advantage of the hydroxy-zone process is that the high rate of reaction and oxidizing power of OH^{o} would then provide the ability to attack not only organics dissolved in the groundwater, but also the persistent or difficult organics in the smear zone as well.

The Hydroxy-Zone advanced oxidation process is a chemical process using OH⁻ and O₃; whereby these chemicals are mixed in a liquid and gas form and are injected into the groundwater below the treatment zone to treat the sorbed and dissolved contaminated layer. The mixture consists of ozone gas and up to 2% KOH solution and is injected under pressure periodically or via pulsing with air through a porous diffuser where the bubbled mixture rises into the treatment zone where hydroxyl radicals form and oxidize and degrade the organic species to mostly carbon dioxide and water. The ozone gas reacts with the KOH or OH⁻ (after KOH dissociates rapidly in the groundwater) to form OH^{o}'s by the following complete chain reaction: 3O₃+OH⁻+H⁺-->2OH^{o}+4O₂⁽¹⁾. Based upon this reaction three (3) ozone molecules produce two (2) OH^{o}.

Those skilled in the art will recognize that the Saudis of an area to be decontaminated will vary, and therefore, the materials and equipment used for a particular project will vary. The following example illustrates how the hydroxy-zone process can be used to clean up a typical automobile gas station and which the ground has been contaminated. The steps in the hydroxy-zone process are as follows:

1. Determine Injection Points.

Injection Points are installed using a picture ½″ diameter solid casing terminated with a porous diffuser set below the groundwater treatment zone, and above the diffuser the borehole surrounding the solid casing will be hydraulically sealed to surface grade.

2. Inject Chemicals.

Inject 2% KOH (potassium hydroxide) solution into the injection points while continuously injecting ozone gas (14-29 grams/hour ozone).

3. Inject/Pulse Air.

Periodically air is injected or pulsed at different time intervals into the injection point to assist in the OH⁻/O₃ mixture dispersion throughout the treatment zone. Those skilled in the art will recognize the process will work without pulsing air. However, air pulsation will improve the efficiency of the reaction process.

4. Generate Ozone.

Ozone generator provides push dry oxygen gas from a dryer-oxygen generator

5. Regulate Ozone Flow.

Control the flow of ozone gas in the air stream using flow meters, a pressure switch, and pressure regulators.

6. Disperse chemicals into the aquifer.

As the KOH-ozone gas mixture is injected into the air stream, or without the air stream via pulsing, the mixture is dispersed into the aquifer through a porous diffuser and the mixture rises through the aquifer and converts into hydroxyl radicals in the treatment zone.

7. Form Hydroxyl Radicals.

As the reaction between OH⁻ and ozone occurs hydroxyl radicals, (OH⁻'s), are formed which scavenge and rapidly oxidize the treatment zone with sorbed and dissolved contaminants in the groundwater.

8. Continue to Supply Hydroxide and Ozone.

The OH^{o} reaction between hydroxide and ozone continues to form as hydroxide and ozone is supplied.

9. Vacuum Extraction.

Based upon the life of the ozone gas in the groundwater it is not anticipated ozone will reach the water table surface. However, vacuum extraction with the use of activated carbon treatment can be utilized in the vadose (i.e. above the water table) zone.

The following method can be used to determine the amount of 45% KOH solution to inject based upon a final molarity to raise pH in treatment area. This method determines the amount of KOH solution needed to inject into the zone of aquifer to be remediated based upon (1) stoichiometry of the hydroxyl radical equation and (2) the dilution equation in chemistry using molarity and volumes.
1. Find the amount of mass in OH− needed for the ozone injected using stoichiometry:
2. Equation for Ozone and OH or radical equation: 303+OH−+H+-->20H Radical+402. (This shows that 3 ozone molecules and 1 hydroxide molecule produces 2 hydroxyl radicals)
3. Determine KOH molecules needed based upon ozone needed for site. Note: make sure that the KOH is per zone utilized.
   MW 03 48 gm/mole Enter 03 Needed=2988.429 gm
   MW KOH 56.1 gm/mole Or Moles of Ozone=62.2589375
   KOH in moles needed=20.75298 moles
   KOH in molarity by dividing the moles needed by Vf=0.000143 M (Note see Final Volume, Vf calc. Below)
4. Using the Molarity Dilution Equation to Calculate KOH Needed to Inject:
   Mix Vi=Mf×Vf rearranging: Mi=(Mf×Vt)Ni Where:
   Mi=initial molarity
   Mf=final molarity
   Vi=initial volume
   Vf=final volume-->(for injection into aquifer use liters and calculate amount of groundwater to treat or zone of groundwater to treat)

### Mf (KOH) 0.000143202 M

Vi 113.55 liters enter Vi in gallons=30
Calc. Vf 144921.0263 liters enter porosity=0.325
enter Vc (cleanup volume) cubic feet=15750

### Mi=0.182765118 M KOH or 1164.242 gms of KOH

Note: Molecular Weight of KOH=56.1 gm/mole

Note: 45% KOH by volume of solution has a solution density of 1450 gm/L so the amount of grams of KOH in one liter of solution=652.5 grams
5. Determine amount in volume (liters) of 45% KOH Solution needed:
   Amount of 45% KOH needed: 1.784279 Liters. Therefore the final solution will entail mixing 1.784279 liter of 45% KOH with 30 gallons of tap water to obtain an initial molarity 0.182765 M Solution KOH which should have a tank pH of 13.26189.

The following is an example of a method of determining ozone injection parameters, oxidation demand, and time to treat.
1. Determine the mass in Aqueous and Soil Media for the target contaminants.
2. Determine the Expected Oxidant Demand Due to Soil, Stoichiometry, Oxidizable Metals and Other Organics.
3. Time to Treat (Duration) Computation—Mass Basis
   The mass of target contaminants calculated from the volume of the impacted area for sorbed phase (soils) and groundwater in units of mass, grams.
   SAR Mass Calculations were conducted and are summarized:

Plume Area 1:

| | | |
|---|---|---|
| Area: | 30 | 35 |
| Thickness: | 15 | |
| Prosity: | 0.325 | |

| | | | | TRPH Minus |
|---|---|---|---|---|
| | | | | Volatiles & |
| | Volatiles | PAH's | TRPH | PAH's |
| Soil Content, gms | 0 | 0 | 0 | 0 |
| Liquid Content, gms | 265 | 15 | 0 | 0 |
| Total Content, gms | 265 | 15 | 0 | 0 |

Area 1:
liquid volume = 144936.3 liters
soil mass = 691031.3 kg

The following method can be used to determine the expected oxidant demand due to soil, stoichiometry, oxidizable metals & other organics.

Total Ozone Demand (TOD)=SOD+SC+OMD+OOD Where:

SOD—Soil Oxidant Demand is the oxidant mass that will be taken up by the aquifer
If the TOC value of 0.045 gms/kg of soil, TOC=0.062 gms/Kg
Area 1—Total Organic Carbon=42843.94 gms. This is determined by Multiplying the Soil SOD is assumed to be 5% of TOC, therefore Area 1, SOD=2142.197 gms ozone.
SC—Stoichiometry Oxidant Demand is a molar ratio of moles of oxidant to moles of the chemical being oxidized in the media.
Stoichiometric Demand, SC=3 gm ozone/gm Volatiles×total gms (soil & liquid) for Volatiles+3 gm ozone/gm PAH×total gms (soil & liquid) for PAHs.
Ozone/Volatiles gram ratio=3 gm ozone per gram of Volatiles
Ozone/PAH gram ratio=3 gm ozone per gram of PAH
Area 1: SC=840 grams ozone
OMD—Oxidizable Metals Demand is again a stoichiometric ratio, such as iron is a typical metal which is oxidized and accounted for in the impacted groundwater Typically for ferrous iron, Fe+2, one mole of ozone can be consumed by two moles of Fe+2. The calculation would be the concentration of dissolved iron multiplied that by the volume of impacted groundwater.
Cfe, iron content in water=0.1 mg/L
by stoichiometry 0.43 gms ozone is used per gm ferrous iron in water
Therefore, OMD=Volume of Water×Cfe×0.43 gm ozone/gm ferrous iron
Area 1: OMD=6.232263 grams ozone.
OOD—Other Organics Demand is the organic chemicals which are dissolved in the groundwater or sorbed to the soil matrix which were not accounted for in the stoichiometric oxidant demand calculation.
In this case TRPH is subtracted from the volatiles & PAH's. TRPH was not detected at the site, OOD equals zero.

### Area 1: OOD=0 gms

### Total Ozone Demand (TOD)=SOD+SC+OMD+OOD

Area 1: TOD=2988.429 gms ozone

### (3) Time to Treat (Duration) Computation—Mass Basis

The ozone generated from the Ozone injection is 2 gms/hour or for 3 injection points 0.7 gms/hour/pt. The total time to treat is derived by dividing the TOD by the ozone supply rate, S
Total Time to Treat in Days: (TOD/S)/24 hrs/day
Area 1 cleanup system will have an ozone generator with a total of 7 injection points. This cleanup system will have an ozone generator that will operate at: (input): 14 grm/hr
Total days to treat: 8.8941 Days

Having discussed the invention in general, we turn now to a detailed discussion of the drawings.

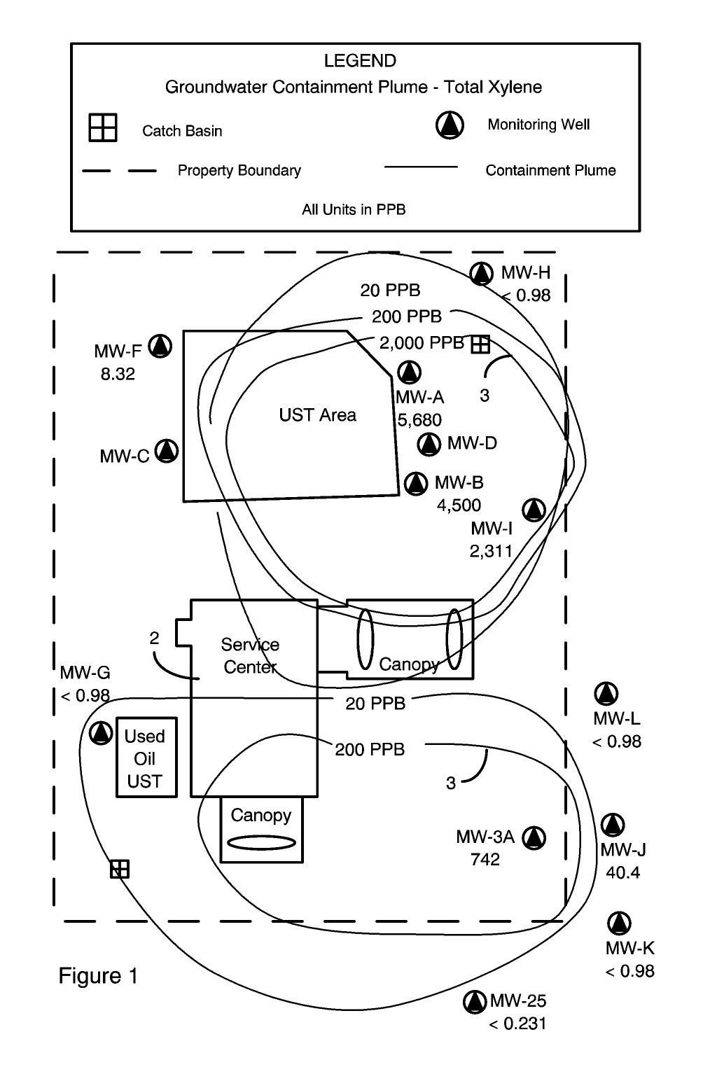

Regarding FIG. 1, it is a diagram of a service station 1 that illustrates a xylene contamination plumes 3 surrounding fuel pumps. The service station building 2 is also illustrated.

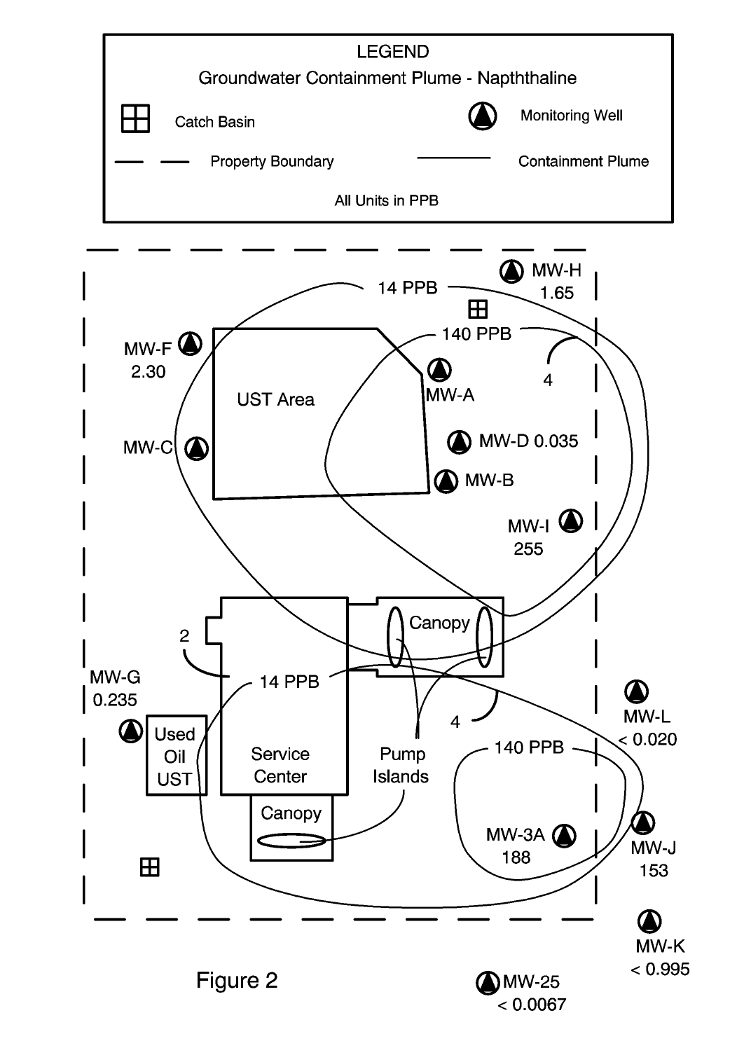

FIG. 2 is a diagram of a service station 1 that illustrates naphthalene contamination plumes 4 surrounding fuel pumps.

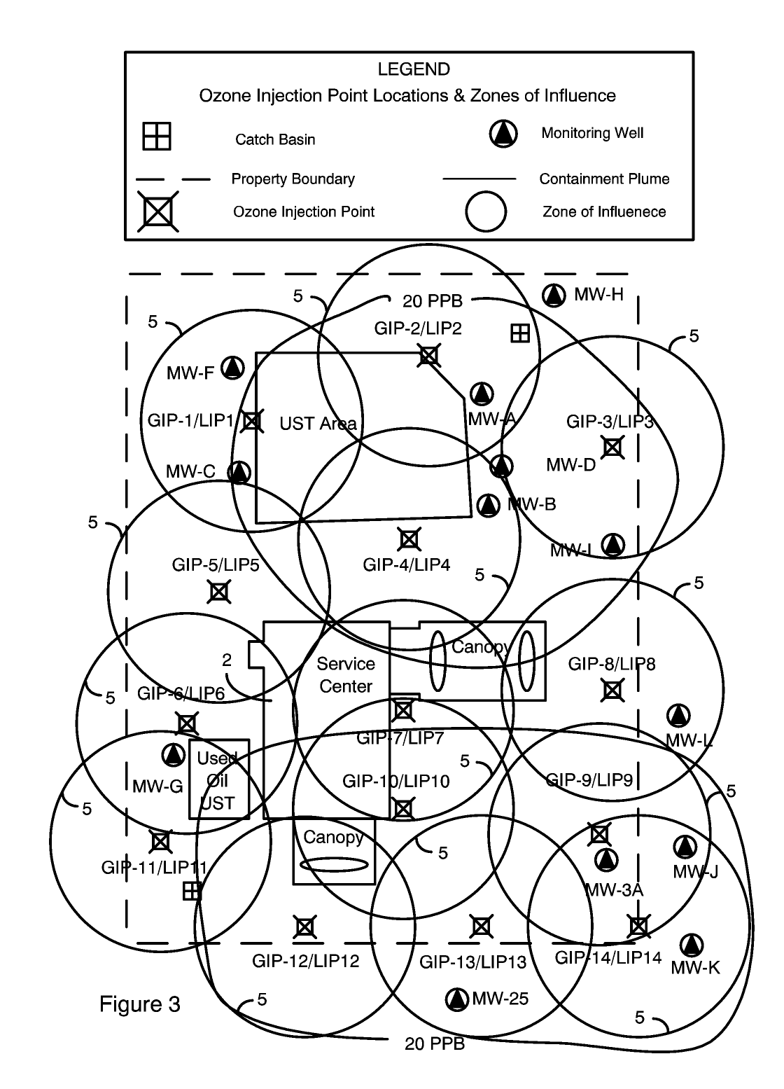

FIG. 3 is a site map of a service station 1 that illustrates ozone injection points 5 and contamination plumes 4.

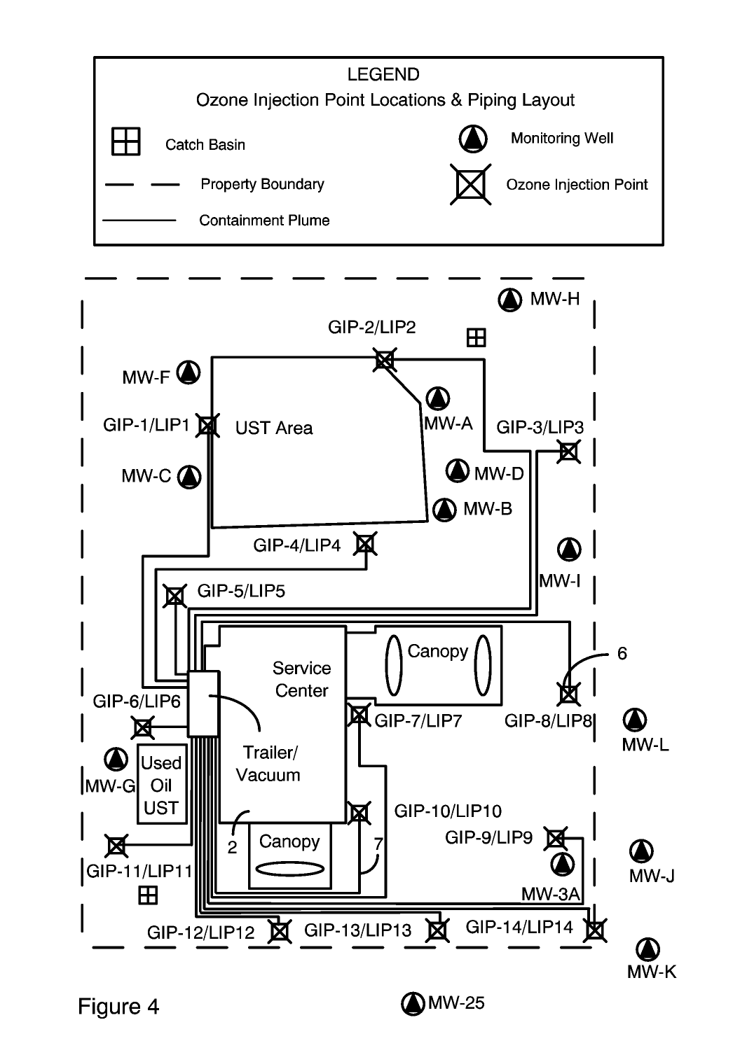

FIG. 4 is a site map of a service station 1 that illustrates ozone injection points 6 and the piping 7 that distributes ozone.

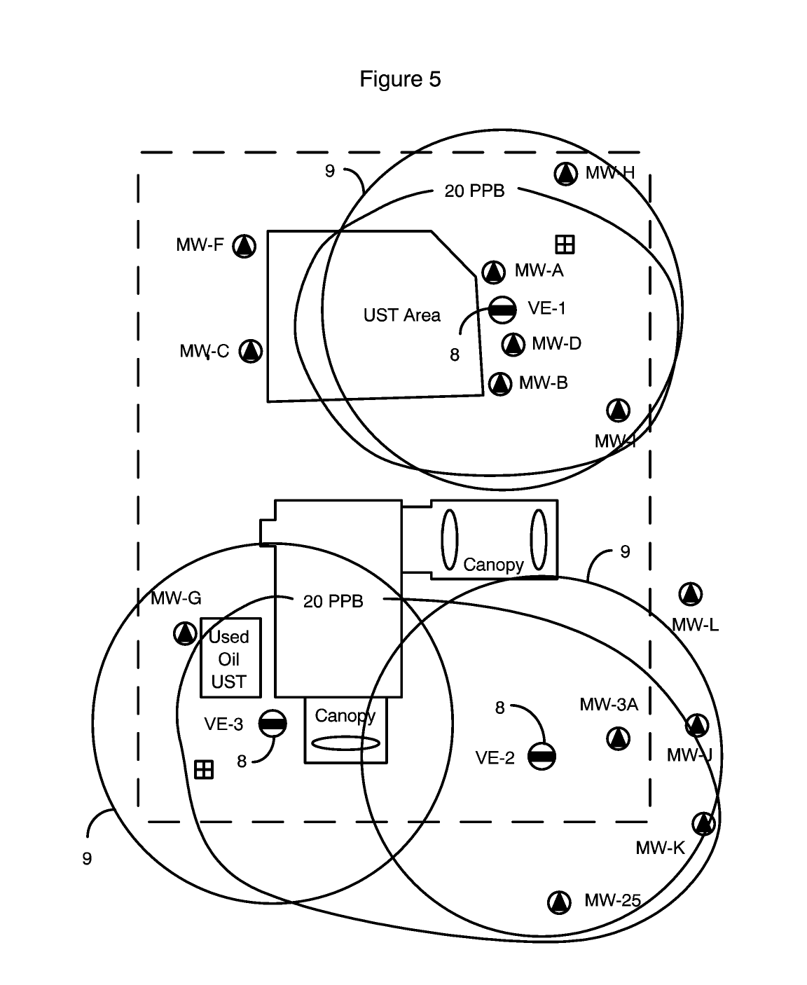

FIG. 5 is a site map of a service station 1 that illustrates vacuum well locations 8 and their respective zones of influence 9.

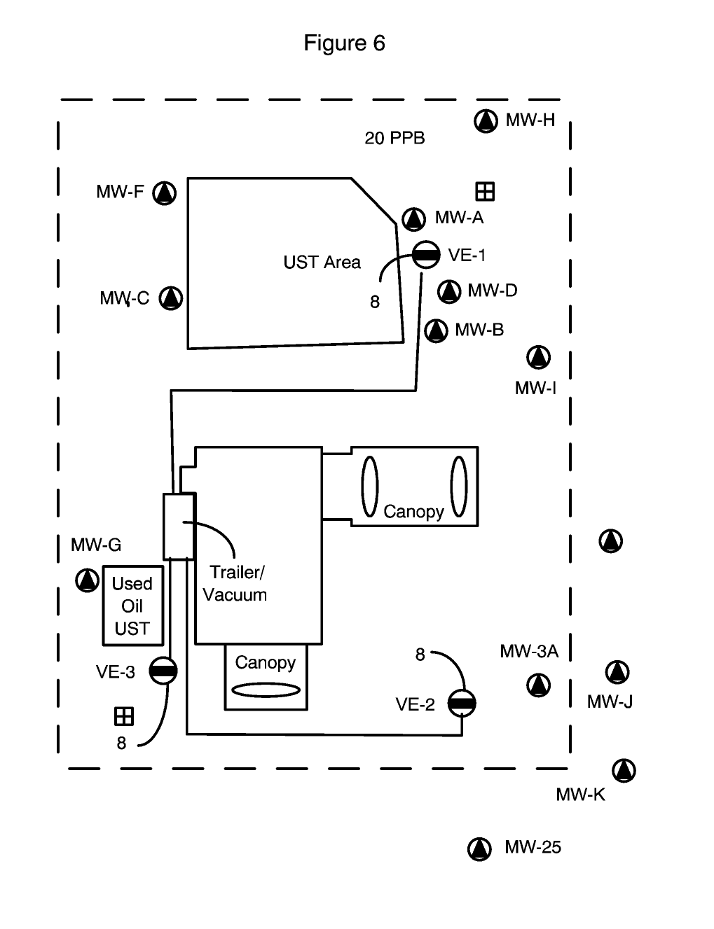

FIG. 6 is a site map of a service station 1 that illustrates vacuum well locations 8 and their vacuum pipes 10.

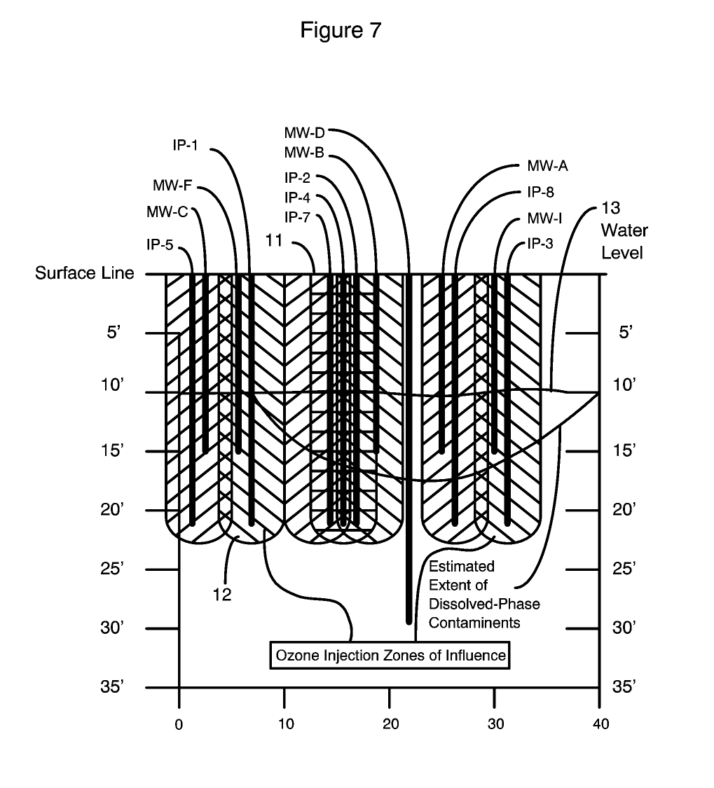

FIG. 7 illustrates the distribution 12 of ozone below the surface 11. The figure also illustrates the distribution 12 of ozone in relation to the water table 13.

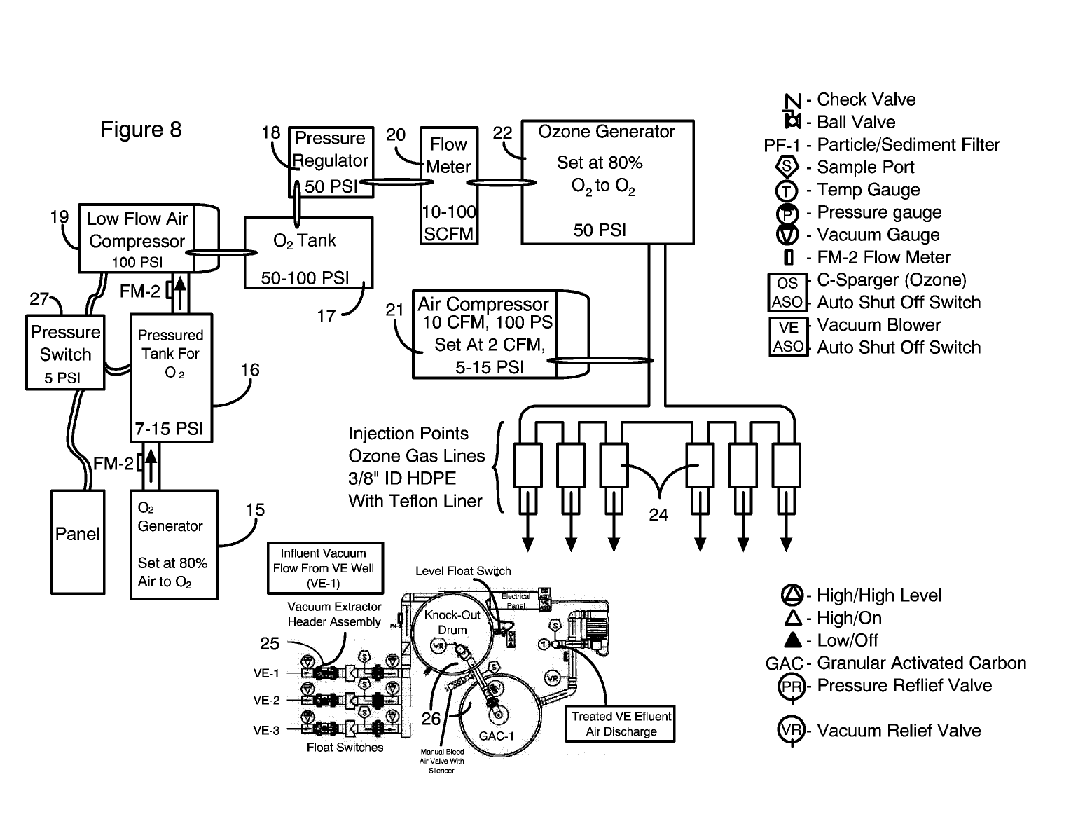

FIG. 8 illustrates a preferred embodiment of the groundwater remediation system 14. In this embodiment, an oxygen generator 15 supplies oxygen to a pressurized oxygen supply tank 16. Oxygen is output from the oxygen supply tank 16 to a low flow air compressor 19. The oxygen supply tank 16 and the low flow air compressor 19 are controlled by pressure switch 27. Oxygen is output from the low flow air compressor 19 to pressure regulator 18. The output of pressure regulator 18 is input to flow meter 20. Flow meter 20 input air to ozone generator 22. Ozone is output from ozone generator 22 and input to ozone injection points 24. Compressed air is also merged with the ozone output from ozone generator 22 via air compressor 21. Also shown in this figure are vacuum extraction headers 25 which feed extracted material to the effluent treatment system 26.

While specific embodiments have been discussed to illustrate the invention, it will be understood by those skilled in the art that variations in the embodiments can be made without departing from the spirit of the invention. Therefore, the invention shall be limited to the scope of the claims.

I claim:

1. A method of remediating groundwater, including the steps of:
Injecting ozone gas into a treatment area;
injecting potassium hydroxide into the treatment area, the potassium hydroxide injected in proximity to the ozone gas such that the potassium hydroxide and ozone react with one another to produce hydroxyl radicals;
using the hydroxyl radicals to react with organic compounds that contaminate groundwater.
